(19) United States
(12) Patent Application Publication
(10) Pub. No.: US 2018/0140952 A1
(43) Pub. Date: May 24, 2018

(54) GAMING SERVER AND METHOD TO GENERATE INFORMATION-RICH PROFILES

(71) Applicant: Sony Interactive Entertainment LLC, San Mateo, CA (US)

(72) Inventors: SHUNSUKE KUNIEDA, SAN FRANCISCO, CA (US); WIVAT KRUAWONGWANICH, SAN FRANCISCO, CA (US); ERIKA OHNO, SAN FRANCISCO, CA (US)

(21) Appl. No.: 15/356,487

(22) Filed: Nov. 18, 2016

(51) Int. Cl. A63F 13/537; A63F 13/35; A63F 13/798; A63F 13/87

(52) U.S. Cl. CPC A63F 13/537; A63F 13/87; A63F 13/798; A63F 13/35

(57) ABSTRACT

Various aspects of a gaming server and method are disclosed herein, which includes receipt of a request from a first electronic device of a plurality of electronic devices communicatively coupled to the gaming server. The received request may comprise a request to compare a gaming profile of a first user associated with the first electronic device with one or more other gaming profiles of one or more other users associated with one or more other electronic devices. A customized view is generated based on a parameter-to-parameter comparison. The criteria for the parameter-to-parameter comparison include a plurality of parameters that are dynamically updated based on gameplay activities of the first user on the first electronic device and the one or more other users on the one or more other electronic devices. Display of the generated customized view may be controlled on the first electronic device based on a defined setting.

### CROSS-REFERENCE TO RELATED APPLICATIONS/INCORPORATION BY REFERENCE

None.

### FIELD

Various embodiments of the disclosure relate to gaming systems. More specifically, various embodiments of the disclosure relate to a gaming server and method to generate information-rich profiles in an online gaming environment.

### BACKGROUND

Recent advancements in the field of online gaming system have enhanced the usability and popularity of various single and multiplayer games and the gaming systems. These games may be played by a single player or more than one player at a time. It may be difficult for a player to find another suitable player in an online gaming environment who may have similar gaming skills for a better compatibility in the gameplay. As a result of the lack of readily usable information, it may be difficult for a user to decide to whom to play with or get motivated to spend more time in the online gaming environment, which in turn may increase dissatisfaction and annoyance among the users. The increase in dissatisfaction and annoyance among the users and a decrease in the gameplay time of the users in the online gaming environment may not be desirable to the online gaming service providers.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A gaming server and method to generate information-rich profiles is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment to generate information-rich profiles in an online gaming environment, in accordance with an embodiment of the disclosure.

FIG. 2 is a block diagram that illustrates an exemplary gaming server to generate information-rich profiles in an online gaming environment, in accordance with an embodiment of the disclosure.

FIG. 3 is a block diagram that illustrates an exemplary electronic device, in accordance with an embodiment of the disclosure.

FIGS. 4A, 4B, 4C, and 4D are block diagrams that illustrate exemplary scenarios and exemplary user interfaces for implementation of the disclosed gaming server and method to generate information-rich profiles in an online gaming environment, in accordance with an embodiment of the disclosure.

FIG. 5 is a flow chart that illustrates exemplary operations to generate information-rich profiles in an online gaming environment, in accordance with an embodiment of the disclosure.

### DETAILED DESCRIPTION

Various implementations may be found in a gaming server and method to generate information-rich profiles in an online gaming environment. Exemplary aspects of the disclosure may comprise an information processing method implemented in a gaming server that may include one or more circuits. The one or more circuits may be communicatively coupled to a plurality of electronic devices. The one or more circuits may receive a request from a first electronic device of the plurality of electronic devices. The received request may comprise a request to compare a gaming profile of a first user with one or more other gaming profiles of one or more other users. The first user and the one or more other users may be associated with the first electronic device and the one or more other electronic devices, respectively. The one or more circuits may further generate a customized view in response to the received request. The customized view may be generated based on a parameter-to-parameter comparison of the gaming profile of the first user with the one or more other gaming profiles of the one or more other users. The criteria for the parameter-to-parameter comparison may include a plurality of parameters. The plurality of parameters may be dynamically updated based on gameplay activities of the first user on the first electronic device and the one or more other users on the one or more other electronic devices. The plurality of parameters may comprise a list of games played and/or owned and frequently played games from the list of games. The plurality of parameters may further include a game level attained, a rare game achievement award, total number of game achievement awards. The plurality of parameters may further comprise total time of gameplay associated with one or more games, a time of availability associated with playing of the one or more games, a list of friends, shared gameplay media information, and/or other gameplay parameters. The one or more circuits may further control display of the generated customized view on the first electronic device 104a. The display of the generated customized view may be controlled based on a defined setting. The defined setting may include at least one of a user-defined setting, a geographical location-based setting, an age-based setting, a device-specific setting, and/or a network-specific setting.

In accordance with an embodiment, the one or more other gaming profiles may be searched based on a request received from the first electronic device. The information processing method may further allow the one or more other gaming profiles to be viewed on the first electronic device. The information processing method may further communicate titles of the one or more games. The titles of the one or more games may be communicated based on console language associated with the first electronic device.

In accordance with an embodiment, the generated customized view may include a profile compatibility of the gaming profile of the first user with respect to the one or more other gaming profiles of the one or more other users. The profile compatibility may be generated based on a profile overview of each of the one or more other gaming profiles of the one or more other users. The profile compatibility may be generated based on the parameter-to-parameter comparison of the plurality of parameters. The profile compatibility may be generated based on common games played by the first user associated with the first electronic device and each of the one or more other users associated with the one or more other electronic devices. The profile compatibility may be generated based on a time of availability of the one or more other users to play the one or more games. The profile compatibility may be generated based on media information of the gameplay of the one or more games shared by the one or more other users.

In accordance with an embodiment, the information processing method may further generate a gameplay compatibility of the first user with the one or more other users with respect to the one or more games. The gameplay compatibility may be generated based on a comparison of achievements of the first user and the one or more other users during gameplay of the one or more games. The gameplay compatibility may be generated based on a comparison of rare achievements of the first user and the one or more other users while playing the one or more games. The gameplay compatibility may be generated based on a comparison of time spent by the first user and the one or more other users while playing the one or more games. The information processing method may further allow the generated gameplay compatibility to be viewed on the first electronic device associated with the first user.

In accordance with an embodiment, the information processing method may further receive a gameplay request from the first electronic device, based on the display of the generated customized view on the first electronic device. The received gameplay request may comprise a request to schedule a gameplay of a game. The game may be identified based on a correlation of the plurality of parameters, associated with the first user and the one or more other users, in the generated customized view. The one or more circuits may further communicate the scheduled gameplay of the game to the first electronic device and the one or more other electronic devices in response to the received gameplay request. The gameplay of the game may be scheduled based on the correlation of the plurality of parameters in the generated customized view.

In accordance with an embodiment, relationship information of the first user with the one or more other users may be generated. The relationship information may comprise a duration of established connection as friends, a frequent co-player from a list of friends, last gameplay time, and/or last online status of the one or more other users. The generated relationship information may be viewed on the first electronic device associated with the first user.

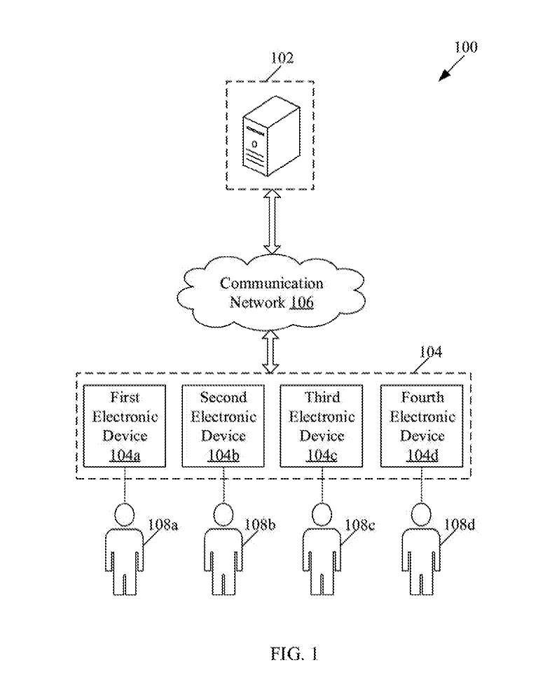

FIG. 1 is a block diagram that illustrates an exemplary network environment to generate information-rich profiles in an online gaming environment, in accordance with an embodiment of the disclosure. With reference to FIG. 1, there is shown an exemplary network environment 100. The exemplary network environment 100 may include an information processing server, such as a gaming server 102. The exemplary network environment 100 may further include a plurality of electronic devices 104, such as a first electronic device 104a, a second electronic device 104b, a third electronic device 104c, and a fourth electronic device 104d. With reference to FIG. 1, there is further shown a communication network 106. The plurality of electronic devices 104 may be communicatively coupled to the gaming server 102, via the communication network 106. There is further shown a plurality of users 108, such as a first user 108a, a second user 108, a third user 108c, and a fourth user 108d, who are associated with the first electronic device 104a, the second electronic device 104b, the third electronic device 104c, and the fourth electronic device 104d, respectively as shown in FIG. 1.

The gaming server 102 may comprise suitable logic, circuitry, interfaces, and/or code that may be configured to communicate with the plurality of electronic devices 104 associated with the plurality of users 108, via the communication network 106. The gaming server 102 may be configured to compare a gaming profile of one of the plurality of users 108, such as the first user 108a, with one or more other users 108b to 108d. The one or more other users 108b to 108d may be associated with one or more other electronic devices 104b to 104d respectively. The gaming server 102 may be a gaming server. Examples of the gaming server 102 may include, but are not limited to, a cloud server, an application server, a database server, a web server, and/or a combination thereof.

Each of the plurality of electronic devices 104 may comprise suitable logic, circuitry, interfaces, and/or code that may be configured to communicate with the gaming server 102, via the communication network 106. A user, such as the first user 108a, may utilize an electronic device, such as the first electronic device 104a, to view one or more other gaming profiles of the one or more other users 108b to 108d. One or more of the plurality of electronic devices 104 may be implemented as a gaming console, a webserver, a mobile device, or other portable electronic devices. Other examples of the plurality of electronic devices 104 may include, but are not limited to, a gaming device, a desktop computer, a smart phone, a tablet computer, a laptop, a wearable electronic device, and/or other such computing devices.

The communication network 106 may include a communication medium through which the gaming server 102 may communicate with the plurality of electronic devices 104. The communication network 106 may be a wired or wireless communication network. Examples of the communication network 106 may include, but are not limited to, a Wireless Fidelity (Wi-Fi) network, a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), a Metropolitan Area Network (MAN), and/or the Internet. Various devices in the exemplary network environment 100 may be configured to connect to the communication network 106, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, Long Term Evolution (LTE), Light Fidelity (Li-Fi), and/or other cellular communication protocols or Bluetooth (BT) communication protocols, including variants thereof.

In operation, the gaming server 102 may receive a request from one of the plurality of electronic devices 104, such as the first electronic device 104a associated with the first user 108a, via the communication network 106. The received request may comprise a request to search and/or view one or more other gaming profiles associated with the one or more other users 108b to 108d. The one or more other users 108b to 108d may be associated with the one or more other electronic devices 104b to 104d, respectively. Based on the received request, the gaming server 102 may be configured to search the one or more other gaming profiles of the one or more other users 108b to 108d. The gaming server 102 may further enable viewing of the one or more other gaming profiles on the first electronic device 104a.

The gaming server 102 may further receive an input from one of the plurality of electronic devices 104, such as the first electronic device 104a, associated with the first user 108a, via the communication network 106. The received input may comprise a request to compare a gaming profile of the first user 108a with the one or more other gaming profiles of the one or more other users 108b to 108d. In response to the received request, the gaming server 102 may be configured to perform a parameter-to-parameter comparison of the gaming profile of the first user 108a with the one or more other gaming profiles of the one or more other users 108b to 108d. The criteria for the parameter-to-parameter comparison may include a plurality of parameters. The plurality of parameters may comprise a list of games played and/or owned, frequently played games from the list of games, a game level attained, a rare game achievement award, and total number of game achievement awards. The plurality of parameters may further comprise total time of gameplay associated with one or more games, a time of availability associated with playing of the one or more games, a list of friends, shared gameplay media information, and/or other gameplay parameters. The plurality of parameters may be dynamically updated by the gaming server 102 based on gameplay activities of the plurality of users 108. For instance, the plurality of parameters may be continuously updated based on gameplay activities of the first user 108a on the first electronic device 104a and the gameplay activities of the one or more other users 108b to 108d on the one or more other electronic devices 104b to 104d.

The gaming server 102 may further generate a customized view based on the parameter-to-parameter comparison. For instance, the generated customized view may comprise a profile compatibility of the gaming profile of the first user 108a with respect to the one or more other gaming profiles of the one or more other users 108b to 108d. In accordance with an embodiment, the profile compatibility may be generated based on a profile overview of each of the one or more other gaming profiles of the one or more other users 108b to 108d. In accordance with an embodiment, the profile compatibility may be generated based on the parameter-to-parameter comparison of the plurality of parameters. For example, one or more common games that are played by the first user 108a and each of the one or more other users 108b to 108d may be displayed on the first electronic device 104a as one of the parameter in the parameter-to-parameter comparison view to denote the profile compatibility. Similarly, the profile compatibility may be generated based on a common time of availability of the one or more other users 108b to 108d to play the one or more games. The profile compatibility may be also generated based on media information of gameplay of the one or more games shared by the one or more other users 108b to 108d. The gaming server 102 may further control display of the generated customized view comprising at least the generated profile compatibility on the first electronic device 104a associated with the first user 108a. The display of the generated customized view on the first electronic device 104a may be controlled based on a defined setting. The defined setting may include a user-defined setting and a geographical location-based setting. The geographical location may correspond to the location of the plurality of users 108 and/or the plurality of electronic devices 104. The defined setting may further include an age-based, a device-specific, and/or a network-specific setting. The age-based setting refers to age of a user as registered at the gaming server 102. The display of the generated customized view may be different for different age groups, as defined in the age-based setting. For example, the fonts, color, and graphics may be set different for teen age group as compared to a user in the age group below thirteen. A device-specific setting may refer to device type, such as a smartphone or a dedicated gaming device where the game is played. The display of the generated customized view may be different for different device types, such as a desktop computer, a smart phone, a tablet computer, a laptop, a wearable electronic device, and/or other such computing devices. The network-specific setting may refer to network-bandwidth of a network used for gaming. For example, the display of the generated customized view may be different for different network-bandwidths. For example, a more detailed and high resolution view may be generated in high bandwidth as compared to a low bandwidth. In accordance with an embodiment, the display of the generated customized view may be different for different types of gaming network used to access the gaming server 102.

The gaming server 102 may be further configured to generate a gameplay compatibility of the first user 108a with the one or more other users 108b to 108d with respect to the one or more games. The gameplay compatibility may be generated based on a comparison of achievements of the first user 108a and the one or more other users 108b to 108d while playing the one or more games. The gameplay compatibility may be generated based on a comparison of rare achievements of the first user 108a and the one or more other users 108b to 108d while playing the one or more games. The gameplay compatibility may be generated based on a comparison of time spent by the first user 108a and the one or more other users 108b to 108d while playing the one or more games. The gaming server 102 may further control the display of the generated customized view comprising at least the generated gameplay compatibility on the first electronic device 104a associated with the first user 108a. The display of the generated customized view on the first electronic device 104a may be controlled based on the defined setting.

The gaming server 102 may further receive an input from the first electronic device 104a associated with the first user 108a, via the communication network 106, based on the display of the generated customized view on the first electronic device 104a. The received input may comprise a gameplay request to schedule a gameplay of a game identified based on a correlation of the plurality of parameters in the generated customized view. The plurality of parameters may be associated with the first user 108a and the one or more other users 108b to 108d. In response to the received input, the gameplay of the game may be scheduled based on the correlation of the plurality of parameters in the generated customized view. The gaming server 102 may further communicate the scheduled gameplay of the game to the first electronic device 104a and the one or more other electronic devices 104b to 104d.

The gaming server 102 may be further configured to generate relationship information of the first user 108a with the one or more other users 108b to 108d. The relationship information may comprise a duration of established connection as friends, a frequent co-player from a list of friends, last gameplay time, and/or last online status of the one or more other users 108b to 108d. The gaming server 102 may further enable the first user 108a to view the generated relationship information on the first electronic device 104a associated with the first user 108a.

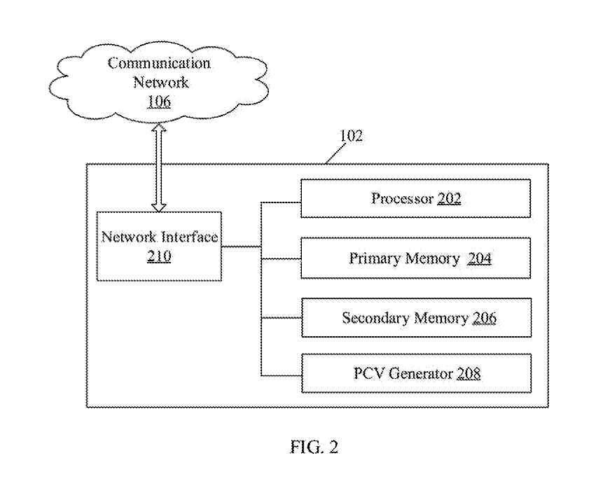

FIG. 2 is a block diagram that illustrates an information processing server for profile comparison in an online gaming environment, in accordance with an embodiment of the disclosure. FIG. 2 is described in conjunction with elements from FIG. 1. With reference to FIG. 2, there is shown a block diagram of an exemplary information processing server, such as the gaming server 102. The gaming server 102 may include one or more circuits, such as a processor 202, a primary memory 204, a secondary memory 206, a parameter-to-parameter comparison view (PCV) generator 208, and a network interface 210. With reference to FIG. 2, there is further shown the communication network 106 (FIG. 1).

In accordance with an embodiment, the processor 202 may be communicatively coupled to the primary memory 204, the secondary memory 206, the PCV generator 208, and the network interface 210. The network interface 210 may be configured to communicate with the plurality of electronic devices 104, via the communication network 106.

The processor 202 may comprise suitable logic, circuitry, interfaces, and/or code that may be configured to execute a set of instructions stored in the secondary memory 206. The processor 202 may be configured to control display of a customized view, generated based on a parameter-to-parameter comparison of a plurality of parameters, on the first electronic device 104a. The processor 202 may be implemented based on a number of processor technologies, which are known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or other processors or control circuits.

The primary memory 204 may comprise suitable logic, circuitry, interfaces, and/or code that may be configured to temporarily store data, such as gaming profiles of the plurality of users 108. Examples of implementation of the primary memory 204 may include, but are not limited to, Random Access Memory (RAM), Dynamic Random Access Memory (DRAM), Static Random Access Memory (SRAM), Thyristor Random Access Memory (T-RAM), Zero-Capacitor Random Access Memory (Z-RAM), cache memory, and/or other volatile memory.

The secondary memory 206 may comprise suitable logic, circuitry, interfaces, and/or code that may be configured to store a machine code and/or a set of instructions executable by the processor 202. The secondary memory 206 may be configured to store one or more algorithms that are executed by the processor 202 to compare the gaming profile with the one or more other gaming profiles. The secondary memory 206 may be further configured to store operating systems and associated applications of the gaming server 102. Examples of implementation of the secondary memory 206 may include, but are not limited to, Read Only Memory (ROM), a flash memory, Hard Disk Drive (HDD), a Solid-State Drive (SSD), a Secure Digital (SD) card, and/or a removable media drive.

The PCV generator 208 may comprise suitable logic, circuitry, interfaces, and/or code that may be configured to compare the gaming profile of the first user 108a with the one or more other gaming profiles of the one or more other users 104b to 104d. The PCV generator 208 may compare the gaming profile with the one or more other gaming profiles based on criteria that may comprise the plurality of parameters. The PCV generator 208 may be implemented as a separate processor or circuitry in the gaming server 102. The PCV generator 208 and the processor 202 may be implemented as an integrated processor or a cluster of processors that perform the functions of the PCV generator 208 and the processor 202. The PCV generator 208 may be implemented as a set of instructions stored in the secondary memory 206, which on execution by the processor 202 may perform the functions and operations of the gaming server 102.

The network interface 210 may comprise suitable logic, circuitry, interfaces, and/or code that may be configured to communicate with the information processing server, such as the gaming server 102 (as shown in FIG. 1), via the communication network 106 (as shown in FIG. 1). The network interface 210 may be implemented by use of known technologies to support wired or wireless communication of the gaming server 102 with the communication network 106. Components of the network interface 210 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

In operation, the processor 202 may be configured to receive a request from one of the plurality of electronic devices 104, via the communication network 106. For example, the processor 202 may receive the request from the first electronic device 104a associated with the first user 108a. The received request may comprise a request to search and view one or more other gaming profiles of the one or more other users 108b to 108d, such as the second user 108b, the third user 108c, and the fourth user 108d. For instance, the one or more other users 108b to 108d may be friends of the first user 108a. In another instance, the one or more other users 108b to 108d may be acquaintances of the first user 108a. In yet another instance, the one or more other users 108b to 108d may be followers of the first user 108a as registered at the gaming server 102. In yet another instance, the one or more other users 108b to 108d may be unknown users engaged in gameplay of one or more games on their respective electronic devices 104b to 104d in an online gaming environment, irrespective of any relationship with the first user 108a.

The processor 202 may be further configured to search the one or more other gaming profiles of the one or more other users 108b to 108d, based on the received search request. For instance, the processor 202 may transmit a query to the primary memory 204 to search for the one or more other gaming profiles of the one or more other users 108b to 108d. In another instance, the processor 202 may transmit the query to a memory unit, such as a profile repository unit (not shown), to search for the one or more other gaming profiles of the one or more other users 108b to 108d. The profile repository unit may be communicatively coupled to the gaming server 102, via the communication network 106. The profile repository unit may also store gaming profiles of users, who are associated with the one or more games in the online gaming environment. Based on the search result, the processor 202 may retrieve the one or more other gaming profiles of the one or more other users 108b to 108d from the primary memory 204 or the profile repository unit.

The processor 202 may allow the plurality of users 108, such as the first user 108a, to view the one or more other gaming profiles retrieved from the primary memory 204 or the profile repository unit. The processor 202 may render a user interface (UI) on a display screen (not shown) of the first electronic device 104a, via the communication network 106. The display of the one or more other gaming profiles of the one or more other users 108b to 108d on the UI, may be performed based on various factors. The factors may include a gameplay status, achievements, or session creation time of the one or more other users 108b to 108d in the gameplay of the one or more games.

The gameplay status may be representative of an availability or unavailability of the one or more other users 108b to 108d for a gameplay of the one or more games in the online gaming environment. The achievements may be representative of one or more targets or goals accomplished by the one or more other users 108b to 108d in the gameplay of the one or more games. The one or more targets or goals may correspond to a progress level attained in the one or more games, total number of trophies, coins, rare trophies, and/or rare coins earned in the one or more games. The session creation time may be representative of an elapsed time duration or available time duration in the gameplay of the one or more games.

Each of the one or more other gaming profiles displayed on the rendered UI may include one or more categories of information. The one or more categories of information may include a basic information category, a game list category, a shared media category, an activity category, and friends and communities category. The basic information category may include profile information of a user from the one or more other users 108b to 108d. For instance, the profile information may include a profile picture (or avatar), a real name (or a display name), and/or online identifier (ID) of the user from the one or more other users 108b to 108d. The profile information may further include a presence indicator that may be indicative of a presence of the user for the gameplay of the one or more games. The profile information may further include a verified account indicator that may be indicative of a verification status of a gaming profile of the associated user from the one or more other users 108b to 108d. The profile information may further include a last login time that may be indicative of a time stamp at which the associated user from the one or more other users 108b to 108d may have logged-in to the online gaming environment. The profile information may include a last gameplay time that may be indicative of a time stamp at which the user from the one or more other users 108b to 108d may have played the one or more games in the online gaming environment. The profile information may also include a total gameplay time that may be indicative of a total time duration for which the user from the one or more other users 108b to 108d may have played the one or more games in the online gaming environment. The profile information may further include a list of languages that may be known to the user from the one or more other users 108b to 108d. In accordance with an embodiment, the profile information may include a profile summary of the user, a total number of trophies won by the user, a level of won trophy, a trophy level progress, a type of trophy and the rarest trophy won by the associated user from the one or more other users 108b to 108d in the gameplay of the one or more games. The profile information of the associated user from the one or more other users 108b to 108d may further include a list of frequently played games, a current gameplay of a game, and a game level attained in the current gameplay. The profile information may include a number of friends, a number of mutual friends, and a number of followers of the user from the one or more other users 108b to 108d. The profile information may further include an availability time to play the one or more games and a status of a transmitted or received friend request.

The game list category may include a list of the one or more games that may have been played or owned by the user from the one or more other users 108b to 108d. The game list category may further include game-specific information, such as won trophies, shared media content, total gameplay time, last gameplay time, and game level progress, for each of the one or more games.

The shared media category may include media content with respect to each of the one or more games that may have been shared by the user from the one or more other users 108b to 108d. The shared media content may correspond to videos, screenshots, broadcasts, and/or archived broadcasts that corresponds to each of the one or more games played by the one or more other users 108b to 108d. The videos, screenshots, broadcasts, and/or archived broadcasts in the shared media content may be available in a sorted order. The processor 202 may sort the one or more videos, screenshots, broadcasts, and/or archived broadcasts in the shared media content based on the most popular content, most recent content, or content type of the videos, screenshots, broadcasts, and/or archived broadcasts.

The activity category may include a log of activities of the user from the one or more other users 108b to 108d. The log of activities may include the last login time, the last gameplay time, the total gameplay time, and the list of frequently played games. The log of activities may further include the recently won trophies related to one or more games. The log of activities may further include recently uploaded media content that corresponds to the one or more games.

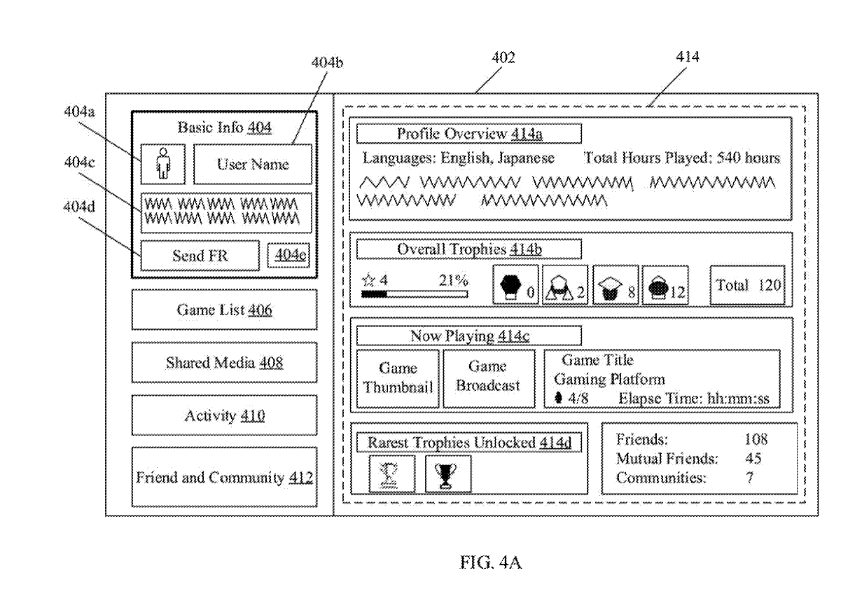

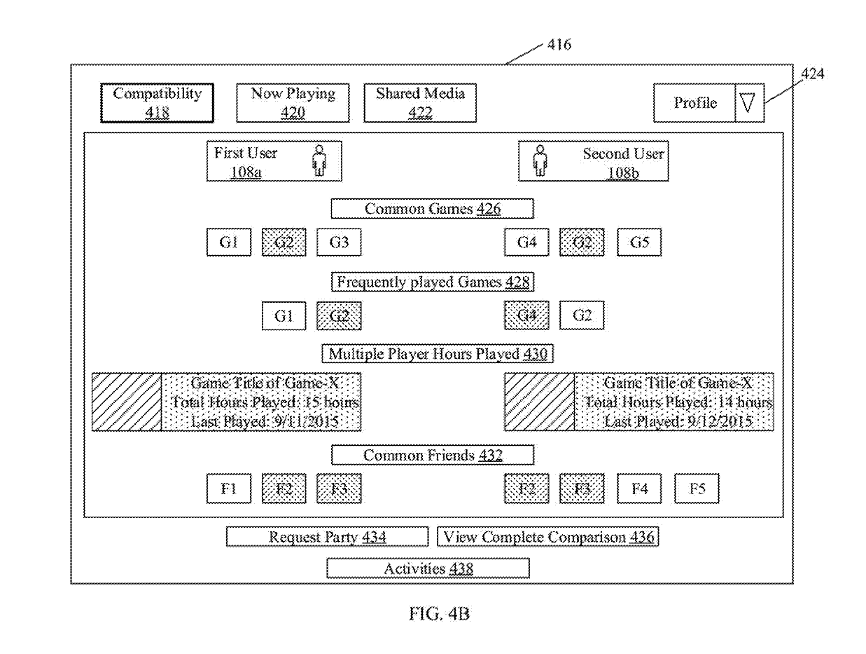

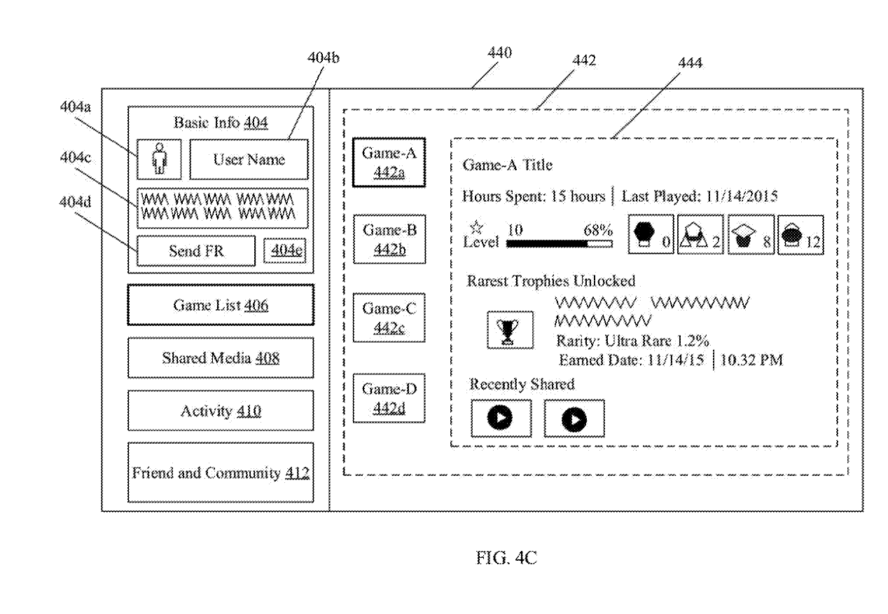

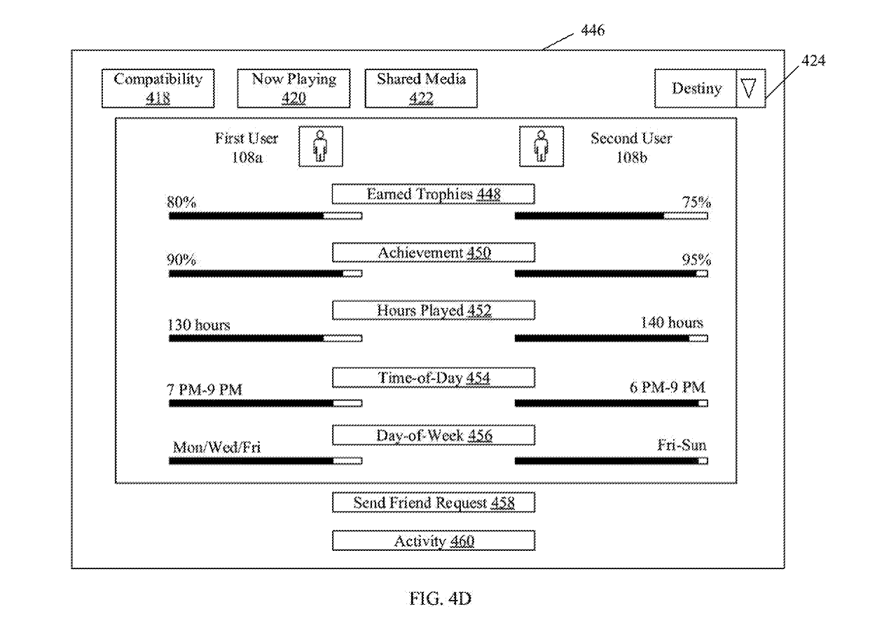

The friends and communities category may include a list of friends of the user from the one or more other users 108b to 108d. The friends and communities category may further include a list of mutual friends, followers, or communities of the associated user from the one or more other users 108b to 108d. The one or more categories of information displayed on the rendered UI are also described in detail, for example, in FIGS. 4A, 4B, 4C, and 4D.

The processor 202 may further receive a comparison request from one of the plurality of electronic devices 104, via the communication network 106. For example, the processor 202 may receive the comparison request from the first electronic device 104a associated with the first user 108a, via the communication network 106. The received comparison request may include a request to compare a gaming profile of the first user 108a with the one or more other gaming profiles of the one or more other users 108b to 108d. In response to the received request, the PCV generator 208 may be configured to perform a parameter-to-parameter comparison of the gaming profile of the first user 108a with the one or more other gaming profiles of the one or more other users 108b to 108d. The PCV generator 208 may be configured to perform the comparison based on the plurality of parameters.

The PCV generator 208 may further generate a customized view based on the parameter-to-parameter comparison. The processor 202 may further control display of the generated customized view on the display screen of the first electronic device 104a associated with the first user 108a. The display of the generated customized view may be controlled based on a defined setting. The generated customized view may comprise the parameter-to-parameter comparison of the plurality of parameters. For instance, the generated customized view may comprise a profile compatibility of the gaming profile of the first user 108a with respect to the one or more other gaming profiles of the one or more other users 108b to 108d. The processor 202 may generate the profile compatibility based on a profile overview of each of the one or more other gaming profiles of the one or more other users 108b to 108d. The processor 202 may generate the profile compatibility based on the parameter-to-parameter comparison of the plurality of parameters. The processor 202 may generate the profile compatibility based on one or more common games from the one or more games that are played by the first user 108a and each of the one or more other users 108b to 108d. The first user 108a and the one or more other users 108b to 108d may play the one or more common games on the first electronic device 104a and the one or more other electronic devices 104b to 104d, respectively, over the communication network 106. The processor 202 may generate the profile compatibility based on the availability time of the one or more other users 108b to 108d to play the one or more games. The processor 202 may generate the profile compatibility based on the media content of the gameplay of the one or more games shared by the one or more other users 108b to 108d.

The generated profile compatibility may be representative of the one or more games that may be common to the first user 108a and the one or more other users 108b to 108d. The generated profile compatibility may be further representative of an overall personality information of the one or more other users 108b to 108d. The generated profile compatibility may further include information about a likely availability time of the one or more other users 108b to 108d to play the one or more games. The generated profile compatibility may also be representative of one or more common friends. The generated profile compatibility may be further representative of interesting information of the media content shared by the one or more other users 108b to 108d. The interesting information may, for example, indicate a sequence of steps to be followed, strategies, and/or skill sets to complete or unlock one or more stages (or levels) of the one or more games, through the shared media content. For instance, the one or more other users 108b to 108d, such as the second user 108b, may share media content, such as a video, of a game from the one or more games. The video may include content that is representative of procedures based on experience of the user who shared the media content, to unlock the one or more stages in the game. Such procedures that may be accessible to the first user 108a through the video shared by the second user 108b and may be referred to as the interesting information.

The processor 202 may be further configured to generate a gameplay compatibility of the first user 108a with the one or more other users 108b to 108d with respect to the one or more games. The gameplay compatibility may correspond to a result of the parameter-to-parameter comparison of the plurality of parameters associated with the one or more games. For instance, the gameplay compatibility may be generated based on the comparison of the achievements of the first user 108a and the one or more other users 108b to 108d during gameplay of the one or more games. Alternatively, the gameplay compatibility may be generated based on the comparison of rare game achievements of the first user 108a and the one or more other users 108b to 108d. The gameplay compatibility may be also generated based on the comparison of the time spent by the first user 108a and the one or more other users 108b to 108d during gameplay of the one or more games.

The processor 202 may allow the first user 108a to view the generated gameplay compatibility on the UI displayed on the display screen of the first electronic device 104a. The generated gameplay compatibility may be representative of game specific skills of the one or more other users 108b to 108d that are similar or different from game skills of the first user 108a. The generated gameplay compatibility may further include comparison information with respect to the one or more games. For instance, the comparison information may correspond to trophy completion, rarest trophies won, gameplay time, such as a time and day of gameplay, a time of last gameplay or a total time of gameplay, and/or the like. The processor 202 may provide the plurality of users 108, such as the first user 108a, an improved experience to view the generated profile and gameplay compatibility in the parameter-to-parameter comparison view. For example, it may be easier for the first user 108a to decide whether he/she wants to be a friend with the one or more other users 108b to 108d or not. It may be further easier for the first user 108a to start or join the gameplay of the one or more games with the one or more other user 108b to 108d based on parameter-to-parameter comparison view. Such parameter-to-parameter comparison view may motivate and encourage the first user 108a to spend more time in an online gaming environment.

The processor 202 may be configured to receive a gameplay request from the first electronic device 104a associated with the first user 108a, via the communication network 106. Alternatively stated, the received gameplay request may refer to a feedback provided of the first user 108a after viewing the generated customized view on the first electronic device 104a. The received gameplay request may include a request to schedule the gameplay of a game. The game may be identified based on a correlation of the plurality of parameters, for example, the profile compatibility and/or the gameplay compatibility, in the generated customized view. In accordance with an embodiment, the game may be identified by a user, such as the first user 108a, based on the customized view displayed on the first electronic device 104a. For instance, the first user 108a may identify a common game, common gaming skills, and game achievement levels between the first user 108a and the second user 108b, based on the correlation of the plurality of parameters in the generated customized view. The correlation of the plurality of parameters may be indicated by a numerical value, for example, a percentage similarity value. In accordance with an embodiment, the game to be scheduled may be automatically identified by the gaming server 102 based on the correlation of the plurality of parameters in the customized view displayed on the first electronic device 104a. For example, the processor 202 may automatically identify a specific game from the one or more games associated with game profile of the first user 108a and the one or more other users 108b to 108d, based on the correlation of the plurality of parameters in the generated customized view. The processor 202 may then schedule the gameplay of the identified game with the first user 108a and the second user 108b.

In accordance with an embodiment, the gameplay of the game may be scheduled in response to the received gameplay request. For example, the gameplay of the game may be scheduled based a common time of availability of the first user 108a and the one or more other users 108b to 108d, for example, as displayed in the generated customized view. The processor 202 may further communicate the scheduled gameplay of the game to the first electronic device 104a and the one or more other electronic devices 104b to 104d.

The processor 202 may be further configured to dynamically update the plurality of parameters based on gameplay activities of the first user 108a on the first electronic device 104a. The processor 202 may further dynamically update the plurality of parameters based on the gameplay activities of the one or more other users 108b to 108d on the one or more other electronic devices 104b to 104d. The processor 202 may further communicate titles of the one or more games. The titles of the one or more games may be communicated based on console language associated with the first electronic device 104a.

The processor 202 may be configured to generate relationship information of the first user 108a with the one or more other users 108b to 108d. The relationship information may comprise at least one of a duration of established connection as friends, a frequent co-player from a list of friends, last gameplay time, and/or last online status of the one or more other users 108b to 108d. The processor 202 may further enable the first user 108a to view the generated relationship information on the display screen of the first electronic device 104a associated with the first user 108a.

In accordance with an embodiment, the processor 202 may be configured to hide various information (for example, game titles, shared media content, and achievements) of the one or more games, based on game privacy selected by the plurality of users 108. For example, the plurality of users 108, such as the second user 108b, may opt in to share a particular media content with certain users, who are friends of the second user 108b, in the game privacy setting. In such a scenario, the first user 108a, who is not a friend of the second user 108b, may not be allowed to view the shared media content. Similarly, the second user 108b, may opt out to share certain information as defined in the game privacy setting. In accordance with an embodiment, the processor 202 may be configured to allow the plurality of users 108, such as the first user 108a, to sort the one or games in the list of games of its gaming profile. The one or games in the list of games may be sorted in the order of games marked as favorite. For instance, the favorite games may be placed on the top followed by the recently played games. The recently played games may be followed by the games in the order of installation date and time. The one or games in the list of games may be further sorted in an alphabetic order of the titles of the one or more games. The one or games in the list of games may be further sorted based on the total gameplay time associated with each of the one or more games.

In accordance with an embodiment, the processor 202 may allow the first user 108a to select a mode from a plurality of modes of comparisons. The plurality of modes may correspond to a full profile comparison mode, a single game comparison mode, a shared media comparison mode, and a communication mode. The full profile comparison mode may be used to view a complete profile of the one or more other users 108b to 108d. A friend invitation may be readily sent to the one or more other users 108b to 108d from within the complete profile of the one or more other users 108b to 108d. The first user 108a may not be limited to utilizing their own profile to send the friend request. The single game comparison mode may be used to view profile comparison with respect to a game. The shared media comparison mode may be used to view the media content shared by the one or more other users 108b to 108d. The communication mode may be used to start a real-time communication with the one or more other users 108b to 108d.

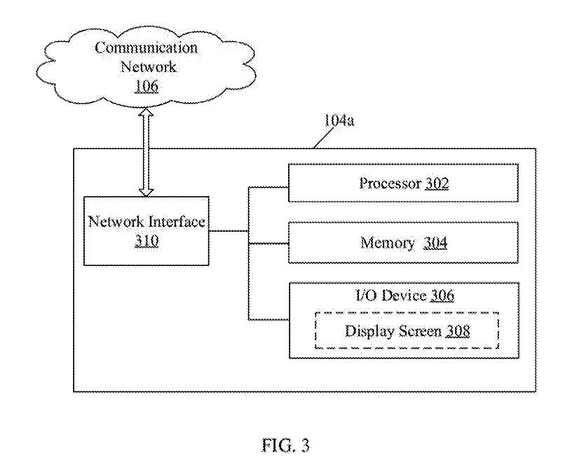

FIG. 3 is a block diagram that illustrates an exemplary first electronic device, in accordance with an embodiment of the disclosure. FIG. 3 is described in conjunction with elements from FIG. 1 and FIG. 2. With reference to FIG. 3, there is shown a block diagram that corresponds to, an exemplary electronic device, such as the first electronic device 104a. The first electronic device 104a may include one or more circuits that may enable the first user 108a to interact with the gaming server 102 or the one or more other users 108b to 108d, via the communication network 106. The one or more circuits may include a processor 302, a memory 304, an input/output (I/O) device 306, a display screen 308, and a network interface 310. The I/O device 306 may include the display screen 308.

In accordance with an embodiment, the processor 302 may be communicatively coupled to the memory 304, the I/O device 306, the display screen 308, and the network interface 310. The network interface 310 may be configured to communicate to the gaming server 102 and/or the one or more other electronic devices 104b to 104d, via the communication network 106.

The processor 302 may comprise suitable logic, circuitry, interfaces, and/or code that may be configured to execute a set of instructions stored in the memory 304. The processor 302 may be further configured to display one or more user interfaces communicated by the network interface 310. Examples of the implementation of the processor 302 may be similar to that of the processor 202 (FIG. 2).

The memory 304 may comprise suitable logic, circuitry, and/or interfaces that may be configured to store a machine code and/or a set of instructions executable by the processor 202. The memory 304 may be further configured to store operating systems and associated applications of the first electronic device 104a. Examples of implementation of the memory 304 may include, but are not limited to, Random Access Memory (RAM), Read Only Memory (ROM), Solid-state Drive (SSD), Hard Disk Drive (HDD), Flash memory, and/or a Secure Digital (SD) card.

The I/O device 306 may comprise suitable logic, circuitry, interfaces, and/or code that may be configured to receive an input from and provide an output to the first user 108a associated with the first electronic device 104a. Examples of the input devices may include, but are not limited to, a camcorder, a touch screen, a joystick, a microphone, a motion sensor, a gaming device, a light sensor, and/or a docking station. Examples of the output devices may include, but are not limited to, the display screen 308, a projector screen, and/or a speaker.

The network interface 310 may comprise suitable logic, circuitry, interfaces, and/or code that may be configured to communicate with an information processing server, such as the gaming server 102 (as shown in FIG. 1), via the communication network 106 (as shown in FIG. 1). The network interface 310 may be implemented by use of known technologies to support wired or wireless communication of the first electronic device 104a with the communication network 106. The network interface 310 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

In operation, the plurality of users 108, such as the first user 108a, may utilize the I/O device 306, to provide an input to communicate a request to the information processing server, such as the gaming server 102, via the communication network 106. The network interface 310 may transmit the request under the control of the processor 302 to view one or more other gaming profiles of the one or more other users 108b to 108d. In response to the transmitted request, the processor 302 may be configured to render the UI on the display screen 308, where the UI may include the one or more other gaming profiles of the one or more other users 108b to 108d. The UI may include additional information of the one or more other gaming profiles. The additional information may refer to one or more categories of information, such as the basic information category, the game list category, the shared media category, the activity category, and friends and communities category. After viewing the additional information, the first user 108a may provide an input by use of the I/O device 306, to transmit a request to compare their gaming profile with the one or more other gaming profiles of the one or more other users 108b to 108d. The first user 108a may provide an input by use of the I/O device 306, to transmit various criteria for the comparison. The criteria may comprise the plurality of parameters.

In response to the transmitted request, the processor 302 may be configured to render the UI on the display screen 308, where the UI may include a customized view. The customized view may comprise the parameter-to-parameter comparison of the plurality of parameters. For instance, the customized view may comprise a profile compatibility and/or a gameplay compatibility of the gaming profile of the first user 108a with respect to the one or more other gaming profiles of the one or more other users 108b to 108d.

The first user 108a may further utilize the I/O device 306, to provide an input to communicate a gameplay request to the gaming server 102, via the communication network 106. The first user 108a may provide the input based on the display of the generated customized view on the first electronic device 104a. The gameplay request may comprise a request to schedule a gameplay of the game with the one or more other users 108b to 108d. In response to the transmitted request, the first electronic device 104a may receive the schedule of the gameplay of the game from the gaming server 102, via the communication network 106. The first user 108a may play the scheduled game with the one or more other users 108b to 108d on the first electronic device 104a, based on the received schedule of the gameplay.

FIGS. 4A, 4B, 4C, and 4D are block diagrams that illustrate exemplary scenarios and user interfaces for implementation of the disclosed information processing server and method to generate information-rich profiles in an online gaming environment, in accordance with an embodiment of the disclosure. FIGS. 4A to 4D are described in conjunction with elements from the FIGS. 1, 2, and 3.

With reference to FIG. 4A, there is shown an exemplary UI, such as a UI 402, which may be rendered on the display screen 308 of the first electronic device 104a. The first user 108a may want to view gaming profiles of the one or more other users 108b to 108d. The first electronic device 104a may communicate a request to the gaming server 102 to search and/or view gaming profiles of the other users 108b to 108d, based on an input provided by the first user 108a. Based on the received request, the gaming server 102 may allow the first user 108a to view the gaming profiles of the other users 108b to 108d on the first electronic device 104a. The first user 108a may select one of the gaming profiles of the other users 108b to 108d, such as the second user 108b.

The first user 108a, by use of the UI 402, may be able to view at a glance one or more categories of information of another user, such as the second user 108b. The one or more categories of information, such as the basic information category, the game list category, the shared media category, the activity category, and friends and communities category, may be displayed in the context of one or more games. The one or more categories of information displayed on the UI 402 may be dynamically updated in real time or near-real time by the processor 202. The update may occur based on gameplay activities of the second user 108b on the second electronic devices 104b.

The gaming profile rendered on the UI 402 may include various UI elements, for example, one or more input tabs, such as a basic info tab 404, a game list tab 406, a shared media tab 408, an activity tab 410, and a friend and community tab 412. The one or more input tabs may correspond to the one or more categories of information. Each of the one or more input tabs may be further associated with a defined area on the UI 402. For instance, the defined area associated with the basic info tab 404 may include a profile image 404a, for example, a profile picture and/or an avatar, of the second user 108b. The defined area associated with the basic info tab 404 may further include a user name 404b, for example, a real name, a display name, and/or an online ID, of the second user 108b. The basic info tab 404 may further include a brief message 404c, such as self-details in about me, posted by the second user 108b, a send friend request (FR) tab 404d and an option tab 404e. The first user 108a may press the send FR tab 404d to send a friend request to the second user 108b from within the gaming profile of the second user 108b, as shown. Further, the first user 108a may click on the option tab 404e to view a current status of the sent request. The defined area associated with the basic info tab 404 may further include an online indicator (not shown) that may indicate about current availability of the second user 108b. The basic info tab 404 may also include a last login time (not shown) and a last gameplay time (not shown) of the second user 108b.

The gaming profile rendered on the UI 402 may further include various other UI elements, such as a profile overview section 414a, overall trophies section 414b, now playing section 414c, and rarest trophies unlocked section 414d, associated with the basic info tab 404. The various other UI elements may be displayed on a separate UI section, for example, a UI section 414 rendered on the UI 402, when the first user 108a may activate or select the basic info tab 404 on the UI 402 with a press or click, as shown in FIG. 4A. Similarly, the various other UI elements (not shown) associated with the game list tab 406, the shared media tab 408, the activity tab 410, and the friend and community tab 412 may be displayed on the separate UI.

The one or more input tabs, such as the basic info tab 404, the game list tab 406, the shared media tab 408, the activity tab 410, and the friend and community tab 412, may enable (allow or permit) the first user 108a to take an action associated with the gaming profile of the second user 108b. For example, the first user 108a may press activate or select the basic info tab 404 with a press or click, to transmit a request, from the first electronic device 104a, to view detailed (or full) profile information of the second user 108b. In response to the received request to view the profile information of the second user 108b, the processor 202 may render the UI section 414, as shown in FIG. 4A. The profile information may include information associated with the profile overview section 414a, the overall trophies section 414b, the now playing section 414c, and the rarest trophies unlocked section 414d, for example, as shown in FIG. 4A.

The profile overview section 414a may include languages that are known to the second user 108b. The profile overview section 414a may further include total hours played by the second user 108b in gameplay of the one or more games, as shown in FIG. 4A. The profile overview section 414a may further include a profile description of the second user 108b.

The overall trophies section 414b may include a trophy level and/or a percentage of progress in the trophy level in the gameplay of the one or more games, as shown. The overall trophies section 414b may further include a total number of trophies (for example, aggregated trophies) unlocked by the second user 108b in the gameplay of the one or more games. The unlocked trophies may also be referred to as trophies that are won or attained in the gameplay of the one or more games. The overall trophies section 414b may further include the total number of different type of trophies won by the second user 108b in the gameplay of each of the one or more games, as shown. For example, trophies of the one or more games may be segregated into various types, such as platinum trophies, gold trophies, silver trophies, and bronze trophies. In such instances, the overall trophies section 414b may further include, the total number of trophies for each type of trophies, unlocked by the second user 108b in the gameplay of each of the one or more games.

The now playing section 414c may display a game thumbnail and/or a game broadcast of a game (or an ongoing session or party) that is currently being played by the second user 108b on the second electronic device 104b, as shown in FIG. 4A. The now playing section 414c may further display a game title and associated gaming platform of the game, as shown in FIG. 4A. The now playing section 414c may further display an elapse time and a number of users in the gameplay of the game, as shown. The processor 202 may further include one or more input tabs in the now playing section 414c. For instance, the one or more input tabs may correspond to a view broadcast tab (not shown), a request-to-watch tab (not shown), a join game tab (not shown), a join party tab (not shown), a join session tab (not shown), a start tab, and/or the like. The processor 202, by means of the one or more input tabs associated with the now playing section 414c, may enable the first user 108a to perform associated actions.

The rarest trophies unlocked section 414d may include one or more rare trophies unlocked by the second user 108b in the gameplay of the one or more games. The processor 202 may further display other miscellaneous information, for example, a count of friends, mutual friends, and/or communities, associated with the second user 108b. The first user 108a may press the game list tab 406, the shared media tab 408, the activity tab 410, or the friend and community tab 412, to transmit a request, from the first electronic device 104a, to view detailed information of the second user 108a that corresponds to the selected tab. In accordance with an embodiment, a user, such as the first user 108a, may click on a preference tab (not shown) to select a preference for the comparison with gaming profiles of one or more of the plurality of users 108, such as the second user 108b. Further, the first user 108a may click on a compatibility tab to transmit a request from the first electronic device 104a to the gaming server 102 to compare the gaming profile of the first user 108a with the gaming profile of the second user 108b, as shown. The comparison may be a done at the gaming server 102 based on the plurality of parameters.

With reference to FIG. 4B, there is shown an exemplary UI, such as a UI 416, displayed on the display screen 308 of the first electronic device 104a associated with the first user 108a. The processor 202 may be configured to render the UI 416 in an event that an input is provided on the compatibility tab or the preference tab on the UI 402. The UI 416 rendered on the display screen 308 of the first electronic device 104a may include a result of the comparison in a parameter-to-parameter comparison view of the plurality of parameters. A profile compatibility of the gaming profile of the first user 108a with respect to the gaming profile of the second user 108b may be displayed on the UI 416. The UI 416 rendered on the display screen 308 of the first electronic device 104a may include various UI elements, such as a compatibility tab 418, a now playing tab 420, a shared media tab 422, and a preference display tab 424. The UI 416 may further display various other UI elements, where each UI element may correspond to a result of the parameter-to-parameter comparison of the plurality of parameters. For instance, the various other UI elements may correspond to, but are not limited to, common games 426, frequently played games 428, multiple player hours played 430, and common friends 432. The UI 416 may further include a request party tab 434, a view complete comparison tab 436, and activities tab 438.

With reference to the common games 426, the processor 202 may display the one or more games associated with the first user 108a and the second user 108b, separately, as shown in FIG. 4B. The processor 202 may further highlight (for example, a color-based highlight) the one or more games that are common between the first user 108a and the second user 108b. For instance, the first user 108a may be associated with games, such as “G1”, “G2”, and “G3”, as shown. The second user 108b may be associated with games, such as “G2”, “G4”, and “G5”, as shown. In such instance, the processor 202 may highlight the game “G2, as the game “G2” is a common game between the first user 108a and the second user 108b. In certain scenarios, the processor 202 may display game title or game thumbnail of common games and exclude other non-common games. In case of more than one common games, the processor 202 may display common games in a sorted order. The sorted order may be determined based on various factors, such as a first time of play, a last time of play, a total hours of play, and/or a count of achievements (trophies) associated with the gameplay of each common game.

With reference to the frequently played games 428, the processor 202 may be configured to display the one or more games that are frequently played by the first user 108a and the second user 108b. For instance, the processor 202 displays the game “G2” associated with the first user 108a as a frequently played game, as shown. Similarly, the processor 202 displays the game “G4” associated with the second user 108b as a frequently played game, as shown. In a scenario where the processor 202 may display more than one frequently played game, the processor 202 may be configured to display frequently played games in a sorted order. The sored order may be determined based on a number of times the frequently played game has been played by a user, such as the first user 108a or the second user 108b. The sorted order may be further determined based on other factors, such as, a first time of play, a last time of play, a total hours of play, and/or a count of achievements (trophies) associated with the gameplay of each frequently played game.

With reference to the multiple player hours played 430, the processor 202 may be configured to display the total number of hours spent by each of the first user 108a and the second user 108b in the gameplay of the one or more games. For instance, the processor 202 may display that the first user 108a has spent “15 hours” in the gameplay of a game, such as “game-X”, from the one or more games, as shown. Similarly, the processor 202 may display that the second user 108b has spent “14 hours” in the gameplay of the “game-X”.

With reference to the common friends 432, the processor 202 may be configured to display one or more names (for example, a real name and/or a user name with or without a profile image) of one or more friends of the first user 108a, who are also friends to the second user 108b. For instance, the processor 202 may display the one or more names of the one or more friends of the first user 108a and the second user 108b, separately, as shown in FIG. 4B. The processor 202 may further highlight (for example, a color-based highlight) the one or more names of the one or more friends who are common to each of the first user 108a and the second user 108b. For instance, the first user 108a may be registered as a friend to each of users, such as “F1”, “F2”, and “F3”, as shown in FIG. 4B. The second user 108b may be registered as a friend of each of users, such as “F2”, “F3”, “F4”, and “F5”. In such an instance, the processor 202 may highlight the users “F2” and “F3” as common friends to both the first user 108a and the second user 108b. In another instance, the processor 202 may exclusively display the one or more names of the one or more friends, who are common to each of the first user 108a and the second user 108b. Further, based on the profile compatibility displayed on the UI 416, the first user 108a may press one of the request party tab 434, the view complete comparison tab 436, and the activities tab 438 to transmit a request to view associated information.

With reference to FIG. 4C, there is shown an exemplary UI, such as a UI 440, displayed on the display screen 308 of the first electronic device 104a associated with the first user 108a. The processor 202 may be configured to render the UI 440 in an event that an input is provided on the game list tab 406 of the UI 402 (FIG. 4A). In response to the received request to view the one or more games, the processor 202 may render a UI section 442 on the display screen 308 of the first electronic device 104a, as shown in FIG. 4C. The UI 442 rendered on the display screen 308 of the first electronic device 104a may include various UI elements, where each UI element may correspond to a game from the one or more games associated with the second user 108b. For instance, the various UI elements may correspond to a game-A 442a, a game-B 442b, a game-C 442c, and a game-D 442d. The first user 108a may select the game-A 442a option to transmit a request to view the information associated with the game-A 442a. In response to the received request to view the information associated with the game-A 442a, the processor 202 may render a UI section 444 on the display screen 308 of the first electronic device 104a, for example, as shown. The processor 202 may display detailed information associated with the gameplay of the game-A 442a by the second user 108b on the UI section 444 rendered on the display screen 308 of the first electronic device 104a. For instance, the processor 202 may display a title of the game-A 442a and hours spent by the second user 108b in the gameplay of the game-A 442a. The processor 202 may further display the total number of trophies unlocked by the second user 108b in the gameplay of the game-A 442a. The total number of trophies unlocked may correspond to different type of trophies, for example, platinum trophies, gold trophies, silver trophies, and bronze trophies. The processor 202 may further display an achievement level for trophies unlocked, and a percentage of completion in the game-A 442a. The processor 202 may further display media content associated with the game-A 442a that may have been recently shared by the second user 108b.

With reference to FIG. 4D, there is shown an exemplary UI, such as a UI 446, displayed on the display screen 308 of the first electronic device 104a associated with the first user 108a. In response to a request to view a gameplay compatibility with respect to the one or more other users 108b to 108d, the processor 202 may render the UI 446 on the display screen 308 of the first electronic device 104a. The UI 446 rendered on the display screen 308 of the first electronic device 104a may further include various UI elements, where each UI element may correspond to a result of the parameter-to-parameter comparison of the plurality of parameters. For instance, the various other UI elements may correspond to, but are not limited to, earned trophies 448, achievement 450, hours played 452, time-of-day 454, and day-of-week 456. The UI 446 may further include a send friend request tab 458 and an activity tab 460.

The earned trophies 448 may refer to a parameter of the plurality of parameters to depict a comparison between trophies earned by the first user 108a and the second user 108b, as shown. The achievement 450 may refer to another parameter of the plurality of parameters to display the comparison between the achievement of the first user 108a and the second user 108b. Similarly, the comparison between the total time spent by each of the first user 108a and the second user 108b in the gameplay of the one or more games, is shown as the hours played 452. The time-of-day 454 may refer to a particular time slot at which both the first user 108a and the second user 108b may be available for the gameplay of the one or more games. The day-of-week 456 may refer to one or more days in a week, such as Monday or Tuesday, on which both the first user 108a and the second user 108b may be available for the gameplay of the one or more games. The first user 108a may instantly press the send friend request tab 458 to transmit a friendship request to the second user 1408b by observation of displayed gameplay compatibility on the UI 446 in the parameter-to-parameter comparison view. The first user 108a may also activate or select the activity tab 460 utilizing a press or click to view one or more recent activities of the second user 108b. Alternatively, based on the gameplay compatibility displayed on the UI 446, the first user 108a may transmit a request to schedule a gameplay of the one or more games with the second user 108b. It may be a simple task for a player, such as the first user 108a, to find another suitable player, such as the second user 108b, who may be have similar gaming skills by use of the displayed information on the UI 446. In another instance, the gaming server 102 may recommend a game to the first user 108a based on the correlation of the plurality of parameters in the generated customized view. For instance, the gaming server 102 may recommend the game based on a gap in a game-specific skill between the first user 108a and the second user 108b. In another instance, the gaming server 102 may recommend the game based on the gap between the achievement of the first user 108a and the second user 108b. In yet another instance, the gaming server 102 may recommend the game that may be common between the first user 108a and the second user 108b.

In another example, players “A”, “B”, and “C” may have played together in the past. In instances when the player “A” selects to compare between Player “B” and Player “C” for match results via its electronic device, such as the first electronic device 104a, the gaming server 102 may control display of the match result of the three players, for example, as given below in the table 1.

TABLE 1
Match Results for three players.

| | Player A | Player B | Player C |
|---|---|---|---|
| Versus (Vs.) Player “A” | — | 1 win 2 loss | 3 wins 0 loss |
| Vs. Player “B” | 2 wins 1 loss | — | 2 wins 3 loss |
| Vs. Player “C” | 3 wins 0 loss | 2 wins 3 loss | — |

The three players, such as the players “A”, “B”, and “C”, may correspond to the first user 108a, the second user 108b, and the third user 108c, respectively.

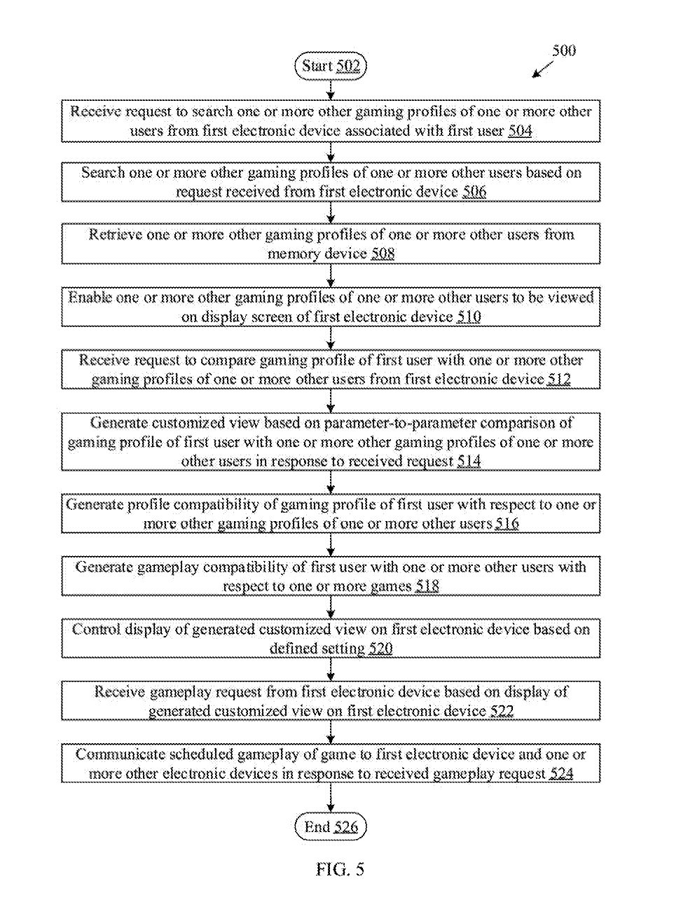

FIG. 5 is a flow chart that illustrates an information processing method for profile comparison in an online gaming environment, in accordance with an embodiment of the disclosure. With reference to FIG. 5, there is shown a flow chart 500. The flow chart 500 is described in conjunction with FIGS. 1, 2, and 3. The method starts at step 502 and proceeds to step 504.

At step 504, a request to search one or more other gaming profiles of the one or more other users 108b to 108d may be received from the first electronic device 104a associated with the first user 108a. The request may be received by the gaming server 102. The one or more other users 108b to 108d may be associated with the one or more other electronic device 104b to 104d.

At step 506, the one or more other gaming profiles of the one or more other users 108b to 108d may be searched based on the request received from the first electronic device 104a. In accordance with an embodiment, the processor 202 may be configured to search the one or more other gaming profiles of the one or more other users 108b to 108d based on the request received from the first electronic device 104a. The processor 202 may search the one or more other gaming profiles of the one or more other users 108b to 108d in a memory device, such as the primary memory 204, or a profile repository unit (not shown) of the secondary memory 206.

At step 508, the one or more other gaming profiles of the one or more other users 108b to 108d may be retrieved from the primary memory 204 and/or the profile repository unit. The processor 202 may be configured to retrieve the one or more other gaming profiles of the one or more other users 108b to 108d from the primary memory 204 and/or the profile repository unit.

At step 510, a view of the one or more other gaming profiles of the one or more other users 108b to 108d may be enabled on the display screen 308 of the first electronic device 104a. The processor 202 may be configured to display the one or more other gaming profiles of the one or more other users 108b to 108d on the display screen 308 of the first electronic device 104a. The display of one or more other gaming profiles for view by the first user 108a may be based on various factors, such as a gameplay status, achievements, or session creation time of the one or more other users 108b to 108d in gameplay of one or more games. An example of the gaming profile of the second user 108a as displayed on the first electronic device 104a, is shown in the FIG. 4A.

At step 512, a request to compare a gaming profile of the first user 108a with the one or more other gaming profiles of the one or more other users 108b to 108d may be received from the first electronic device 104a associated with the first user 108a. In accordance with an embodiment, the processor 202 may be configured to receive the request from the first electronic device 104a, via the communication network 106.

At step 514, a customized view may be generated based on a parameter-to-parameter comparison of the gaming profile of the first user 108a with the one or more other gaming profiles of the one or more other users 108b to 108d in response to the received request. The PCV generator 208 may be configured to generate the customized view based on a parameter-to-parameter comparison of the gaming profile of the first user 108a with the one or more other gaming profiles of the one or more other users 108b to 108d. The criteria for the parameter-to-parameter comparison may comprise a plurality of parameters. The plurality of parameters may be dynamically updated based on gameplay activities of the first user 108a on the first electronic device 104a and the one or more other users 108b to 108d on the one or more other electronic devices 104b to 104d. The generated customized view may include a profile compatibility and/or a gameplay compatibility.

At step 516, the profile compatibility of the gaming profile of the first user 108a may be generated with respect to the one or more other gaming profiles of the one or more other users 108b to 108d. The PCV generator 208 may be configured to generate the profile compatibility of the gaming profile of the first user 108a with respect to the one or more other gaming profiles of the one or more other users 108b to 108d. The profile compatibility may be generated based on the result of the comparison that comprises at least the parameter-to-parameter comparison of the plurality of parameters.

At step 518, a gameplay compatibility of the first user 108a with the one or more other users 108b to 108d may be generated with respect to the one or more games. In accordance with an embodiment, the processor 202 may be configured to generate the gameplay compatibility of the first user 108a with the one or more other users 108b to 108d with respect to the one or more games. The gameplay compatibility may be generated based on the comparison of achievements, rare game achievements and/or gameplay time of the first user 108a and the one or more other users 108b to 108d in the gameplay of the one or more games.

At step 520, the display of the generated customized view on the first electronic device 104a may be controlled based on a defined setting. The processor 20-2 may be configured to control the display of the generated customized view on the first electronic device 104a based on a defined setting. The defined setting may include a user-defined, a geographical location-based, an age-based, a device-specific, and/or a network-specific setting. An example of the display of the customized view that comprises the profile compatibility between the first user 108a and the second user 108b is depicted in the FIG. 4D. An example of the display of the customized view that comprises the gameplay compatibility between the first user 108a and the second user 108b is depicted in the FIG. 4D.

At step 522, a gameplay request may be received from the first electronic device 104a based on display of the generated customized view on the first electronic device 104a. The processor 202 may be configured to receive the gameplay request from the first electronic device 104a based on the display of the generated customized view on the first electronic device 104a. The gameplay request may comprise a request to schedule a gameplay of a game. The game may be identified, by the first user 108a or the gaming server 102, based on a correlation of the plurality of parameters, associated with the first user 108a and the one or more other users 108b to 108d, in the generated customized view.

At step 524, the scheduled gameplay of the game may be communicated to the first electronic device 104a and the one or more electronic device 104b to 104d in response to the received gameplay request. The processor 202 may be configured to communicate the scheduled gameplay of the game to the first electronic device 104a and the one or more electronic device 104b to 104d in response to the received gameplay request. The gameplay of the game may be scheduled based on the correlation of the plurality of parameters in the generated customized view. Based on the scheduled gameplay of the game, the first user 108a and the one or more other users 108b to 108d may play the game on their respective electronic devices, over the communication network 106. Control may pass to end 526.

In accordance with an embodiment of the disclosure, an information processing server is disclosed. The information processing server, such as the gaming server 102 (shown in FIG. 1), may comprise one or more circuits, such as the processor 202 and the PCV generator 208 (shown in FIG. 2), that may be configured to receive an input from a first electronic device 104a associated with the first user 108a. The input may be received to compare a gaming profile of the first user 108a with one or more other gaming profiles of the one or more other users 108b to 108d associated with the one or more other electronic devices 104b to 104d. The PCV generator 208 may be configured to generate a customized view based on a parameter-to-parameter comparison of the gaming profile of the first user 108a with the one or more other gaming profiles of the one or more other users 108b to 108d. The criteria for the parameter-to-parameter comparison may include the plurality of parameters that are dynamically updated based on gameplay activities of the first user 108a on the first electronic device 104a and the one or more other users 108b to 108d on the one or more other electronic devices 104b to 104d. The processor 202 may be further configured to control display of the generated customized view on the first electronic device based on a defined setting.

It may also be convenient for a player, such as the first user 108a, to see at a glance in the parameter-to-parameter comparison view, what the one or more other users 108b to 108d, such as the second user 108b, have achieved in the context of one or more games. The parameter-to-parameter comparison view may provide readily usable information for profile compatibility and gameplay compatibility in a non-cluttered view. For example, the first user 108a, by use of UIs, such as the UIs 402, 416, 430, and 436, may be able to identify other compatible players based on their gaming skills. It may be convenient for the first user 108a to find another suitable user having similar gaming skills by use of the generated customized view for an enhanced and more engaging gameplay in a multiplayer game. The generated customized view may depict parameter-to-parameter comparison of the plurality of parameters. For example, the first user 108a may be further able to identify game specific skills of the second user 108b. Further, based on the view of the other gaming profiles and/or the generated customized view, it may be easier for a user to decide whether they want to be a friend of other users or not. Further, based on the identification of the game specific skills of the second user 108b in the generated customized view, the first user 108a may transmit a request to schedule a gameplay of a game identified based on the correlation of the plurality of parameters, associated with the first user 108a and the second user 108b. In response to the gameplay request, the processor 202 may communicate the scheduled gameplay of the game to the first electronic device 104a and the second electronic device 104b. The gameplay of the game may be scheduled based on the correlation of the plurality of parameters in the generated customized view. Thus, an unknown user, such as the second user 108b who may not be a party to the server-client interaction, such as the gaming server 102 and the first electronic device 104a, may be able to play the identified game with a most relevant and compatible player, such as the first user 108a, for gameplay of the scheduled game.

Currently, conventional systems merely provide static information of the users with limited information with respect to profiles and games associated with the users in a network-based gaming environment. An overall profile similarity between two users may not provide satisfactory information for game related decision making as compared to the parameter-to-parameter comparison of the plurality of parameters. Due to lack of information-rich profiles, the users may not be motivated to spend more time in game-related social interaction. In contrast, the disclosed information processing server, such as the gaming server 102, performs an effective and efficient parameter-to-parameter comparison of the gaming profiles of a user with other gaming profiles of other users for the plurality of parameters. Based on such comparison, the gaming server 102 may generate the customized view that may assist the user to play more games with the other users. The operations performed by the processor 202 and/or the PCV generator 208, and a result of the feedback, such as the gameplay request, received from the first electronic device 104a, the functioning of the gaming server 102 may be improved to identify another user to invite for gameplay at the scheduled time. The gaming server 102 provides a mechanism to the other user to be able to play the identified game with a most relevant and compatible player, such as the first user 108a, for gameplay of the scheduled game at the scheduled convenient time. Consequently, the gameplay time of the other user may also be increased.

The ability of the gaming server 102 to display the results of the comparison in the customized view, such as the parameter-to-parameter comparison view, provides an information-rich decision making tool to a user that encourage the user to expand their gaming network, gaming skills, and spend more time in the online gaming environment.

Further, the information-rich profiles of the plurality of users 108 may be dynamically updated at the gaming server 102 in a dedicated gaming network, such as the communication network 106. The gaming server 102 allows each of the plurality of users 108 to search for other connections based on a variety of non-static criteria, such as recently played games and trophies won, and perform a parameter-to-parameter comparison of oneself with the profile of another user; thereby, providing a more personalized, accurate way to find and make social connections in the dedicated gaming network. The variety of non-static criteria may correspond to the plurality of parameters that are dynamically updated based on gameplay activities of the plurality of users 108 on their respective electronic devices. After a social connection has been established, joint game play and communities may be initiated.

Various embodiments of the disclosure may provide a non-transitory computer-readable medium and/or storage medium, wherein there is stored thereon, a machine code and/or a set of instructions with at least one code section executable by a machine and/or a computer to compare a gaming profile of the first user 108a with one or more other gaming profiles of the one or more other users 108b to 108d associated with the one or more other electronic devices 104b to 104d. The at least one code section in the gaming server 102 may cause the machine and/or computer to perform the operations that comprise generation of a customized view based on the comparison. The generated customized view may comprise a parameter-to-parameter comparison view of the plurality of parameters. The at least one code section in the gaming server 102 may cause the machine and/or computer to perform the operations that comprise control of display of the generated customized view on the first electronic device 104a based on a defined setting. The at least one code section in the gaming server 102 may cause the machine and/or computer to perform the operations that comprise receiving a gameplay request from the first electronic device 104a, based on the display of the generated customized view on the first electronic device 104a. The received gameplay request may comprise a request to schedule a gameplay of a game identified based on a correlation of the plurality of parameters, associated with the first user 108a and the one or more other users 108b to 108d, in the generated customized view. The at least one code section in the gaming server 102 may cause the machine and/or computer to perform the operations that comprise communicating the scheduled gameplay of the game to the first electronic device 104a and the one or more other electronic devices 104b to 104d in response to the received gameplay request.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A gaming server, comprising:
one or more circuits communicatively coupled to a plurality of electronic devices, said one or more circuits configured to:
receive a request from a first electronic device of said plurality of electronic devices to compare a gaming profile of a first user associated with said first electronic device with one or more other gaming profiles of one or more other users associated with one or more other electronic devices;
generate a customized view based on a parameter-to-parameter comparison of said gaming profile of said first user with said one or more other gaming profiles of said one or more other users in response to said received request, wherein criteria for said parameter-to-parameter comparison comprise a plurality of parameters that are dynamically updated based on gameplay activities of said first user on said first electronic device and said one or more other users on said one or more other electronic devices; and
control display of said generated customized view on said first electronic device based on a defined setting.

2. The gaming server according to claim 1, wherein said plurality of parameters comprise at least two of a list of games played and/or owned, frequently played games from said list of games, a game level attained, a rare game achievement award, total number of game achievement awards, total time of gameplay associated with one or more games, a time of availability associated with playing of one or more games, a list of friends, shared gameplay media information, and/or other gameplay parameters.

3. The gaming server according to claim 1, wherein said one or more circuits are further configured to:
search for said one or more other gaming profiles based on a request from said first electronic device; and
enable said one or more other gaming profiles to be viewed on said first electronic device.

4. The gaming server according to claim 1, wherein said one or more circuits are further configured to communicate titles of one or more games based on console language associated with said first electronic device.

5. The gaming server according to claim 1, wherein said generated customized view comprises a profile compatibility of said gaming profile of said first user with respect to said one or more other gaming profiles of said one or more other users.

6. The gaming server according to claim 5, wherein said profile compatibility is generated based on a profile overview of each of said one or more other gaming profiles of said one or more other users.

7. The gaming server according to claim 5, wherein said profile compatibility is generated based on said parameter-to-parameter comparison of said plurality of parameters.

8. The gaming server according to claim 5, wherein said profile compatibility is generated based on common games played by said first user associated with said first electronic device and each of said one or more other users associated with said one or more other electronic devices.

9. The gaming server according to claim 5, wherein said profile compatibility is generated based on a time of availability of said one or more other users to play said one or more games, and/or wherein said profile compatibility is generated based on media information of said gameplay of said one or more games shared by said one or more other users.

10. The gaming server according to claim 5, wherein said one or more circuits are further configured to:
generate a gameplay compatibility of said first user with said one or more other users with respect to said one or more games; and
enable said generated gameplay compatibility to be viewed on said first electronic device associated with said first user.

11. The gaming server according to claim 10, wherein said gameplay compatibility is generated based on a comparison of achievements and/or rare achievements of said first user and said one or more other users while playing said one or more games.

12. The gaming server according to claim 10, wherein said gameplay compatibility is generated based on a comparison of time spent by said first user and said one or more other users while playing said one or more games.

13. The gaming server according to claim 1, wherein said defined setting include at least one of a user-defined setting, a geographical location-based setting, an age-based setting, a device-specific setting, or a network-specific setting.

14. The gaming server according to claim 1, wherein said one or more circuits are further configured to generate relationship information of said first user with said one or more other users, wherein said relationship information comprises at least one of a duration of established connection as friends, a frequent co-player from a list of friends, last gameplay time, and/or last online status of said one or more other users.

15. The gaming server according to claim 14, wherein said one or more circuits are further configured to enable viewing said generated relationship information on said first electronic device associated with said first user.

16. An information processing method to generate information-rich profiles for gaming, comprising:
receiving, by one or more circuits in a gaming server communicatively coupled to a plurality of electronic devices, a request from a first electronic device of said plurality of electronic devices to compare a gaming profile of a first user with one or more other gaming profiles of one or more other users associated with one or more other electronic devices;
generating, by said one or more circuits, a customized view based on a parameter-to-parameter comparison of said gaming profile of said first user with said one or more other gaming profiles of said one or more other users, wherein criteria for said parameter-to-parameter comparison comprise a plurality of parameters that are dynamically updated based on gameplay activities of said first user on said first electronic device and said one or more other users on said one or more other electronic devices; and
controlling, by said one or more circuits, display of said generated customized view on said first electronic device based on a defined setting.

17. The information processing method according to claim 16, wherein said generated customized view comprises a profile compatibility of said gaming profile of said first user with respect to said one or more other gaming profiles of said one or more other users in said parameter-to-parameter comparison.

18. The information processing method according to claim 16, further comprising generating, by said one or more circuits, a gameplay compatibility of said first user with said one or more other users with respect to said one or more games, wherein said generated gameplay compatibility is displayed on said first electronic device associated with said first user in said parameter-to-parameter comparison.

19. The information processing method according to claim 18, wherein said gameplay compatibility is generated based on a comparison of achievements and/or rare achievements of said first user and said one or more other users during gameplay of said one or more games.

20. A gaming server, comprising:
one or more circuits communicatively coupled to a plurality of electronic devices, said one or more circuits configured to:
receive a comparison request from a first electronic device of said plurality of electronic devices to compare a gaming profile of a first user associated with said first electronic device with one or more other gaming profiles of one or more other users associated with one or more other electronic devices;
generate a customized view based on a parameter-to-parameter comparison of said gaming profile of said first user with said one or more other gaming profiles of said one or more other users in response to said received request, wherein criteria for said parameter-to-parameter comparison comprise a plurality of parameters that are dynamically updated based on gameplay activities of said first user on said first electronic device and said one or more other users on said one or more other electronic devices;
control display of said generated customized view on said first electronic device based on a defined setting;
receive a gameplay request from said first electronic device, based on said display of said generated customized view on said first electronic device, to schedule a gameplay of a game identified based on a correlation of said plurality of parameters, associated with said first user and said one or more other users, in said generated customized view; and
communicate said scheduled gameplay of said game to said first electronic device and said one or more other electronic devices in response to said received gameplay request, based on said correlation of said plurality of parameters in said generated customized view.
